(19) United States
(12) Patent Application Publication
(10) Pub. No.: US 2021/0060476 A1
(43) Pub. Date: Mar. 4, 2021

(54) NANOMATERIAL INCLUDING NANOFIBERS AND BEADS FOR HEPA AIR FILTER MEDIA

(71) Applicant: Focus Industries Limited, Hong Kong (CN)

(72) Inventors: Kit Fong WONG, Hong Kong (CN); Yin Shu MIAO, Hong Kong (CN); Sin LI, Hong Kong (CN); Ho Wang TONG, Hong Kong (CN); Connie Sau Kuen KWOK, Hong Kong (CN); Yu Hang LEUNG, Hong Kong (CN)

(21) Appl. No.: 16/960,325

(22) PCT Filed: Jun. 14, 2018
(86) PCT No.: PCT/CN2018/091308

§ 371 Date: Jul. 7, 2020

Related U.S. Application Data
(60) Provisional application No. 62/648,401, filed on Mar. 27, 2018.

(51) Int. Cl. B01D 46/54; B01D 39/04; B01D 39/08; B01D 46/52; B01D 46/00; B01J 20/28; B01J 20/26; B01J 20/24; B01J 20/10; B01J 20/32

(52) U.S. Cl. CPC B01D 46/546; B01D 2239/1258; B01D 39/083; B01D 46/521; B01D 46/0028; B01D 46/0001; B01J 20/28028; B01J 20/28007; B01J 20/28085; B01J 20/261; B01J 20/262; B01J 20/24; B01J 20/103; B01J 20/3231; B01D 2239/1233; B01D 2239/1241; B01D 2239/0613; B01D 2239/1216; B01D 2239/025; B01D 2239/0442; B01D 2239/0631; B01D 2239/0645; B01D 2239/0654; B01D 2239/10; B01D 39/04

(57) ABSTRACT

Nanomaterials (100) in particular HEPA air filter media. One embodiment is a nanomaterial (100) that includes a plurality of nanofibers (140) that form a randomly interwoven network defining three-dimensional pores (160) therein. The nanomaterial further includes a plurality of beads (120) with a bead diameter of 2-20 μm that are distributed randomly within the plurality of nanofibers (140). The beads (120) support the nanofibers (140) to prevent the pores (160) from collapsing.

### FIELD OF INVENTION

The present invention relates to nanomaterials and in particular HEPA air filter media.

### BACKGROUND

Nanofibers have desirable properties that make them capable of wide-ranging technological and commercial application. Nanofibers are useful candidates for application as a filtration medium but lack physical strength due to their nano size. Advancements in nanomaterials with better mechanical integrity are needed.

### SUMMARY

One example embodiment is a nanomaterial that includes a plurality of nanofibers that form a randomly interwoven network defining three-dimensional pores therein. The nanomaterial further includes a plurality of beads with a bead diameter of 2-20 μm that are distributed randomly within the plurality of nanofibers. The beads support the nanofibers to prevent the pores from collapsing.

Example embodiments relate to apparatus and methods that provide a filtration medium that includes a substrate layer, a nanofiber layer and a plurality of beads. The nanofiber layer coats the substrate layer and includes a plurality of nanofibers that form a randomly interlaced matrix defining three-dimensional pores within. The plurality of beads are randomly interspersed within the plurality of nanofibers and support the nanofibers to prevent the pores from collapsing. In one example embodiment, the beads have a bead diameter of 2-20 μm.

Example embodiments relate to a method of preparing a filtration medium that include providing at least one substrate layer, producing threads of nanofibers containing beads that are dispersed irregularly and at random along a length of each nanofiber to generate a plurality of beaded nanofibers, and depositing the beaded nanofibers onto the surface of the substrate layer to create a coating of randomly oriented interwoven nanofibers with three-dimensional pores of 5-50 μm to produce at least one nanofiber filtration layer.

Other example embodiments are discussed herein.

### BRIEF DESCRIPTION OF THE DRAWINGS

FIG. 1 is a diagram of a nanomaterial in accordance with an example embodiment.

FIG. 2 is a scanning electron microscopy micrograph of a nanomaterial in accordance with an example embodiment.

FIG. 3A is a diagram of microfibers in accordance with an example embodiment.

FIG. 3B is a diagram of nanofibers in accordance with an example embodiment.

FIG. 4 is a diagram of a filtration medium in accordance with an example embodiment.

FIG. 5 is a diagram showing the different components of an atmospheric plasma treatment (APT) system and free surface electrospinning in accordance with an example embodiment.

FIG. 6 is a flow diagram of a method of preparing a filtration medium in accordance with an example embodiment.

### DETAILED DESCRIPTION

Nanofibers have properties including small fiber diameter, high porosity and high surface area to volume ratio that make them an important material capable of wide-ranging application. One such application is as a HEPA air filtration medium. Nanofibers are a desirable filtration medium in view of their high filtration efficiency and high specific surface area. However, one problem with nanofibers is their weak mechanical integrity. Nanofibers used in conventional filtration mediums are inherently weak. Conventional filtration mediums have attempted to overcome this weakness in various ways but have not been able to provide a nanomaterial with enhanced mechanical integrity. Example embodiments solve this problem.

Example embodiments relate to a nanomaterial that includes a plurality of nanofibers and a plurality of beads. The beads may be part of the same material as the nanofibers and are formed as thicker or irregular droplets of 2-20 μm in diameter along the length of the nanofibers as the nanofibers are formed. The plurality of nanofibers form a randomly interwoven network defining three-dimensional pores within. The plurality of beads with a bead diameter of 2-20 μm are randomly distributed within the plurality of nanofibers and support the nanofibers to prevent the pores from collapsing. The beads improve the mechanical integrity of the nanomaterial.

Example embodiments relate to an air filtration medium that includes a substrate layer, a nanofiber layer, and a plurality of beads. The nanofiber layer coats the substrate layer and includes a plurality of nanofibers that form a randomly interlaced matrix defining three-dimensional pores within. The plurality of beads with a bead diameter of 2-20 μm are randomly interspersed within the plurality of nanofibers and support the nanofibers to prevent the pores from collapsing.

Example embodiments relate to a method of preparing an air filtration medium that include providing at least one substrate layer, producing threads of nanofibers containing beads that are dispersed irregularly and at random along a length of each nanofiber to generate a plurality of beaded nanofibers, and depositing the beaded nanofibers onto the surface of the substrate layer to create a coating of randomly oriented interwoven nanofibers with three-dimensional pores of 5-50 μm to produce at least one nanofiber filtration layer.

In one example embodiment, the beads in the nanofiber filtration layer reinforce the nanofibers and prevent them from collapsing, providing the nanofiber filtration layer with increased air permeability. In an example embodiment, the beads and the nanofibers are formed at the same time.

In an example embodiment, the nanofibers have a diameter of 10-1000 nm. In another example embodiment the pores have a pore size of 1-10 μm. In an example embodiment, the nanofibers have a diameter of 100-500 nm. In a further example embodiment, the pores have a pore size of 3-8 μm. In an example embodiment, each bead is part of at least one nanofiber. In another example embodiment, each bead is an irregularity that forms a bulge along the length of at least one nanofiber. In an example embodiment, the beads have a bead diameter of 5-15 μm. In one example embodiment, the beads support the nanofibers and prevent delamination.

In an example embodiment, the nanofibers are made from one or more polymers selected from a group consisting of polyvinylidene fluoride (PVDF), poly(vinylidene fluoride-co-hexafluoropropene) (PVDF-co-HFP), polyamide 6 (PA-6), poly(hexamethyleneadipamide), polystyrene, polysulfone, polyethersulfone, polyethylene oxide, polyvinyl chloride, cellulose acetate, chitosan and zein.

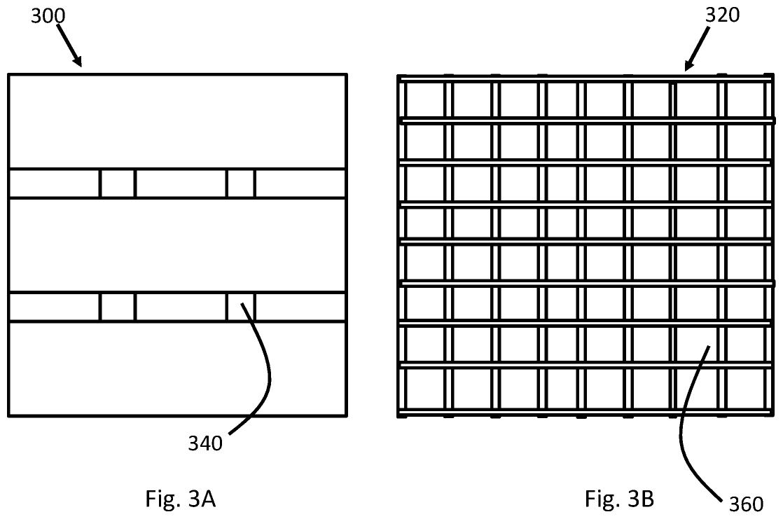

The high specific area of nanofibers, as shown in FIG. 3B which shows a large number of pores 360, allows for a high loading capacity of various agents which improves the functionality and performance of the nanomaterial. In an example embodiment, the nanofibers may be treated with antimicrobial agents and volatile organic compound (VOC) removal agents. Antimicrobial agents may include but are not limited to thymol, chlorhexidine gluconate and polyhexamethylene biguanide (PHMB). VOC removal agents may include but are not limited to halloysite, loess and zeolites.

In an example embodiment, the substrate layer of the air filtration medium comprises a plurality of microfibers. In an example embodiment, the microfibers have a diameter of 2-30 μm. In a further example embodiment, the substrate layer is selected from, but not limited to, polypropylene (PP), polyethylene (PE), polyethylene terephthalate (PET), PET reinforced glass fibers, or a combination thereof. In an example embodiment, the nanofibers are covalently bonded to the microfibers with an adhesion strength higher than 0.01N. In an example embodiment, the filtration medium may be composed of chemical bonds including but not limited to C—C, C—N, C—O and CONH.

In an example embodiment, the basis weight of the nanofiber layer is 0.1-10 grams per square meter (gsm). In another example embodiment, the basis weight of the nanofiber layer is 0.5-1 gsm. In an example embodiment, the nanofiber layer has an air permeability range of 4-20 cm³/cm²/s under air flow pressure of 125 pascal (Pa).

One example embodiment functionalizes the air filtration medium with agents that provide the air filtration medium with additional properties. In an example embodiment, the nanofiber layer is treated with antimicrobial agents to prevent microbial activity in a filtrate that the filtration medium is used as a filter for. In another example embodiment, antimicrobial agents prevent biological contamination of the air filtration medium. The treatment of the nanofibers with antimicrobial agents prevent the proliferation of microbes trapped by the air filtration medium and increases the shelf life of the air filtration medium

The antimicrobial agents may include but are not limited to thymol, chlorhexidine gluconate and polyhexamethylene biguanide (PHMB). In another example embodiment, the nanofiber layer is treated with volatile organic compound (VOC) removal agents. The VOC removal agents include but are not limited to halloysite, loess and zeolites. In an example embodiment, the filtration medium may have viral removal capability. In another example embodiment, the filtration medium neutralizes odors and chemicals and removes allergens including dust, pollen and mold.

In an example embodiment, the air filtration medium may be folded or pleated. In a further example embodiment, the air filtration medium is a high efficiency particulate air (HEPA) filter with an E13 level of filtration efficiency.

In an example embodiment, the air filtration medium is pleated into a “V” configuration with corrugated aluminium separators between the pleats to form a filter element. The filter element is then bonded into a rigid frame using a special polyurethane compound and sealed to form a HEPA filter. The HEPA filter is further sealed when installed in equipment in order to prevent air flow and the sub-micron particles it contains from by-passing the HEPA filter. In an example embodiment, the HEPA filter is further sealed by use of a closed cell neoprene gasket. In an example embodiment, the HEPA filter has a depth of 150 mm. In another example embodiment, the HEPA filter has a depth of 300 mm.

In an example embodiment, the air filtration medium may capture airborne contaminants by mechanisms including but not limited to inertia impaction, interception and Brownian motion.

In an example embodiment, the microfibers in the substrate layer are treated with an atmospheric plasma treatment (APT) system before the beaded nanofibers are deposited on the substrate layer. In one example embodiment, the duration of the APT is 2-10 seconds. In another example embodiment, the duration of the APT is 3-6 seconds. The APT system applies stable and uniform plasma to the microfibers at a low frequency of 1-2 kHz. In another example embodiment, the frequency is 1.3-1.5 kHz. A mixture of helium (He) and oxygen (O₂) is used as plasma carrier gas with a He:O₂ ratio of 100:0-98:2. In an example embodiment, the He:O₂ ratio is 99:1. In an example embodiment, the gas flow of helium is 10-30 L/min. In a further example embodiment, the gas flow of helium is 18-22 L/min. In an example embodiment, the gas flow of oxygen is 0.1-0.5 L/min. In a further example embodiment, the gas flow of oxygen is 0.2-0.4 L/min. In an example embodiment, the time gap between the end of the APT treatment and the start of the deposition of the beaded nanofibers is 5-30 seconds. In another example embodiment, the time gap is 8-12 seconds.

In an example embodiment, the beaded nanofibers are produced by free surface electrospinning. In an example embodiment, the beaded nanofibers are produced from polymer resins not limited to polyvinylidene fluoride (PVDF) and poly(vinylidene fluoride-co-hexafluoropropene) (PVDF-co-HFP) dissolved in organic solvents including dimethylformamide (DMF) with a concentration range of 10%-20%. In a further example, the concentration range is 13%-17%. Organic solvent soluble salts including but not limited to tetraethylammonium chloride (TEAC), tetraethylammonium bromide (TEAB) and benzyltriethylammonium chloride (BTEAC) are added to the polymer solution, and the concentration is 0.1%-5%. In a further example embodiment, the concentration is 0.5%-2%. In an example embodiment, the organic solvent soluble salts including TEAC, TEAB, and BTEAC vary the conductivity of the polymer solution and destabilize the polymer solution to form beaded nanofibers. In one example embodiment, the conditions in the electrospinning chamber are 5%-50%, or 10%-20% relative humidity, inward air flow of 50-100 m³/min or 70-90 m³/min, and outward air flow of 100-170 m³/min or 120-140 m³/min.

The processing parameters for electrospinning, including but not limited to electric field, air flow difference, carriage speed, and substrate speed, are optimized. For example, the electric field is 0.1-0.5 kV/mm. In another example embodiment, the electric field is 0.2-0.4 kV/mm. In an example embodiment, the air flow difference is 0-120 m³/h. In another example embodiment, the air flow difference is 30-70 m³/h. In an example embodiment, the carriage speed is 25-100 mm/sec. In another example embodiment, the carriage speed is 40-80 mm/sec. In an example embodiment, the substrate speed is 20-8000 mm/min. In another example embodiment, the substrate speed is 100-2000 mm/min.

In one example embodiment, the nanofibers have a diameter of 10-1000 nm, the beads have a diameter of 2-20 μm, and the distance between the beads is 5-50 μm. In another example embodiment, the nanofibers have a diameter of 100-500 nm, the beads have a diameter of 5-15 μm, and the distance between the beads is 10-30 μm.

In one example, the folded air filtration medium is assembled with other microfibrous layers to form a HEPA filter with a filtration efficiency of 99.97% or above when tested with aerosol at the most penetrating particle size while maintaining a pressure drop of 50 mmH₂O or below.

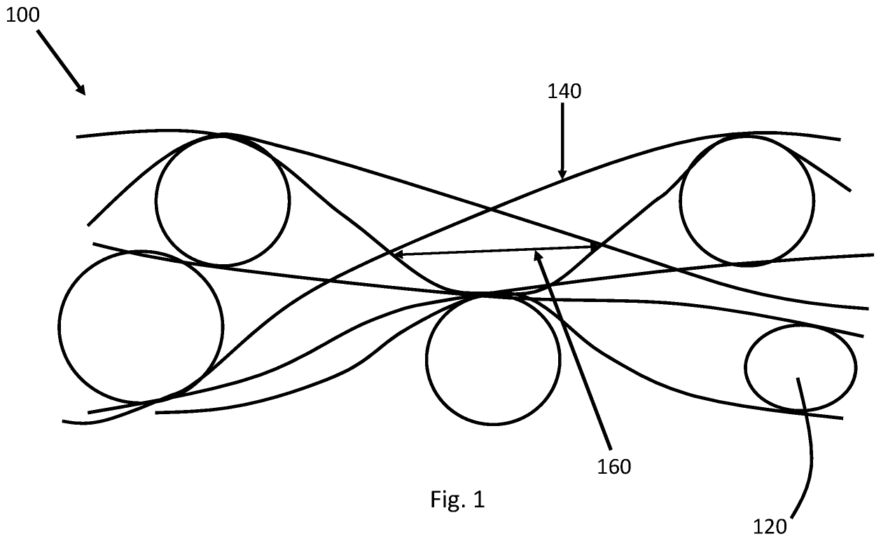

FIG. 1 is a diagram of a nanomaterial 100 that includes a plurality of nanofibers 140 that form a randomly interwoven network defining three-dimensional pores 160 therein and a plurality of beads 120 with a bead diameter of 2-20 μm that are distributed randomly within the plurality of nanofibers 140 in accordance with an example embodiment. The beads 120 provide structural support to the nanofibers 140 to prevent the pores 160 from collapsing in accordance with an example embodiment.

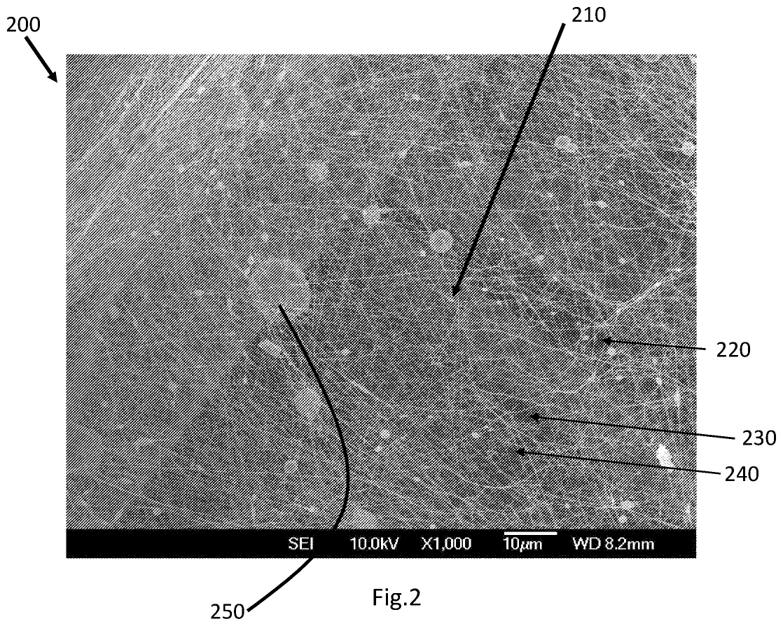

FIG. 2 is a scanning electron microscopy micrograph 200 of a nanomaterial including a plurality of randomly interweaving nanofibers 210 defining three-dimensional pores within the interwoven network, 220, 230, 240, and a plurality of beads 250 that are interspersed at random within the plurality of nanofibers 210.

FIG. 3A is a diagram of microfibers 300 including pores 340 in accordance with an example embodiment. FIG. 3B is a diagram of nanofibers 320 including pores 360 in accordance with an example embodiment. The microfibers 300 in FIG. 3A have fewer pores 340 than the pores 360 in the nanofibers 320 in FIG. 3B in accordance with an example embodiment.

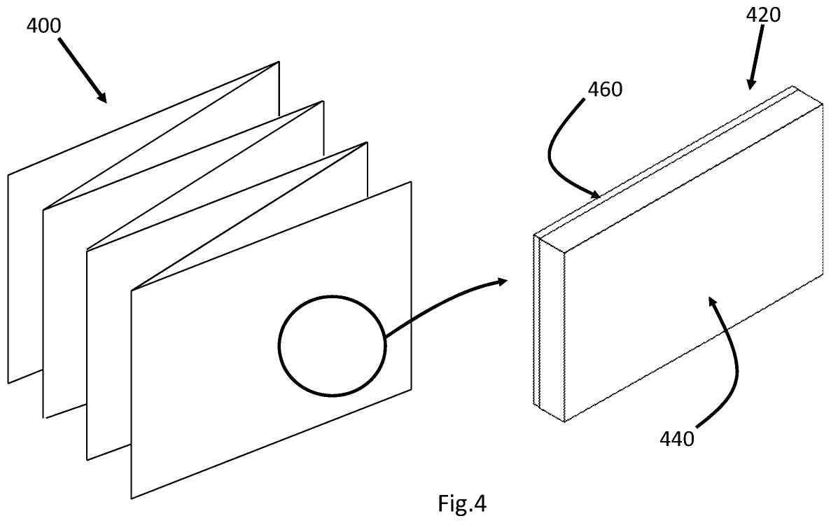

FIG. 4 is a filtration medium 420 that has been folded 400 in accordance with an example embodiment. The filtration medium 420 includes a substrate layer 440 and a nanofiber layer 460 that coats the substrate layer 440.

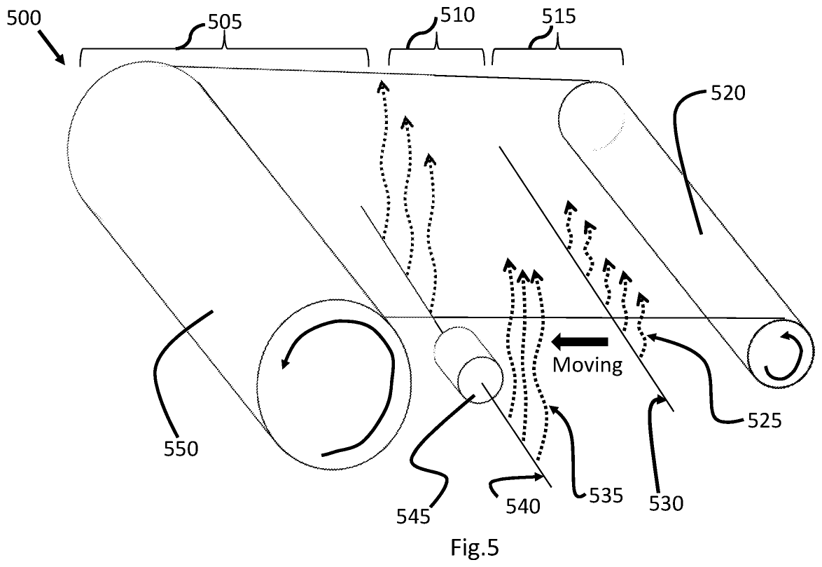

FIG. 5 shows different components 500 of an APT system and free surface electrospinning used to prepare a filtration medium 505 in accordance with an example embodiment.

The unwinding system 520 unwinds the substrate layer 515 and the atmospheric plasma treatment (APT) system 530 applies uniform and stable plasma 525 to the substrate layer 515 to produce a substrate layer that has undergone APT treatment 510. The moving reservoir 545 applies polymer solution onto the spinning electrode 540 producing a polymer jet 535 that becomes nanofiber after solvent evaporation and deposits beaded nanofibers onto a surface of the substrate layer that has undergone APT treatment 510 to produce a nanofiber filtration layer, and the filtration medium comprising a substrate layer and a nanofiber filtration layer 505 is rewound by the rewinding system 550. In an example embodiment, the substrate layer comprises microfibers.

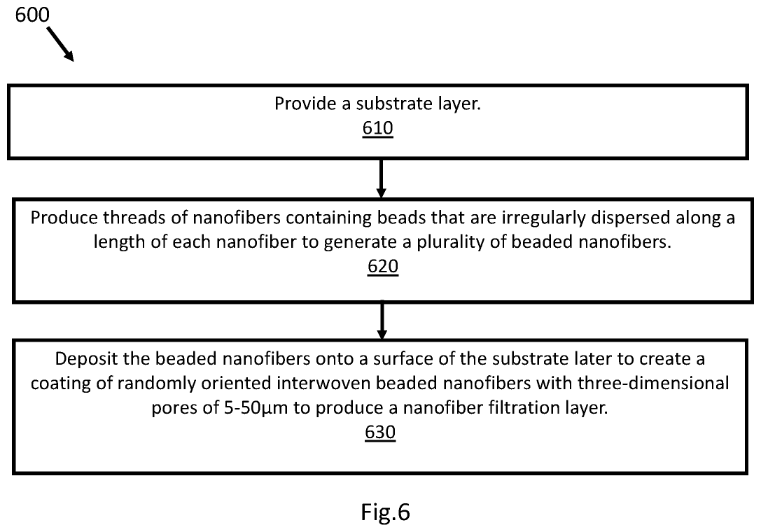

FIG. 6 shows a method of preparing an air filtration medium 600 in accordance with an example embodiment.

A substrate layer is provided 610. Threads of nanofibers containing beads that are irregularly dispersed along a length of each nanofiber to generate a plurality of beaded nanofibers are produced 620.The beaded nanofibers are deposited onto a surface of the substrate layer 610 to create a coating of randomly oriented interwoven beaded nanofibers 620 with three-dimensional pores of 5-50 μm to produce a nanofiber filtration layer 630.

In an example embodiment, the air filtration medium 600 undergoes additional processes including but not limited to lamination and pleating to form a HEPA air filtration medium.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

Methods discussed within different figures can be added to or exchanged with methods in other figures. Further, specific numerical data values (such as specific quantities, numbers, categories, etc.) or other specific information should be interpreted as illustrative for discussing example embodiments. Such specific information is not provided to limit example embodiment.

As used herein, a “nanomaterial” is a material comprising particles or constituents of nanoscale dimensions, including but not limited to nanofibers with diameters of 10-1000 nm.

As used herein, a “bead” is a lump of material of regular or irregular shape of diameter of approximately 2-20 μm. A bead is an irregular swelling or protuberance that forms a bulge along the length of, along varying lengths of, and/or along random lengths of, at least one nanofiber. A singular bead, a plurality of beads or no beads may form along the length of at least one nanofiber.

What is claimed is:

1. A nanomaterial, comprising:
a plurality of nanofibers that form a randomly interwoven network defining three-dimensional pores therein; and
a plurality of beads with a bead diameter of 2-20 μm that are distributed randomly within the plurality of nanofibers
wherein the beads support the nanofibers to prevent the pores from collapsing.

2. The nanomaterial of claim 1, wherein the nanofibers have a diameter of 10-1000 nm.

3. The nanomaterial of claim 1, wherein each bead is part of at least one nanofiber and is an irregularity that forms a bulge along the length of the at least one nanofiber.

4. The nanomaterial of claim 1, wherein the pores have a pore size of 1-10 μm.

5. The nanomaterial of claim 1, wherein the nanofibers are made of a polymer material selected from the group consisting of polyvinylidene fluoride (PVDF), poly(vinylidene fluoride-co-hexafluoropropene) (PVDF-co-HFP), polyamide 6 (PA-6), poly(hexamethyleneadipamide), polystyrene, polysulfone, polyethersulfone, polyethylene oxide, polyvinyl chloride, cellulose acetate, chitosan and zein.

6. A filtration medium, comprising:
a substrate layer; and
a nanofiber layer coating the substrate layer, the nanofiber layer including a plurality of nanofibers that form a randomly interlaced matrix defining three-dimensional pores therein; and
a plurality of beads with a bead diameter of 2-20 μm that are distributed randomly within the plurality of nanofibers
wherein the beads support the nanofibers to prevent the pores from collapsing.

7. The filtration medium of claim 6, wherein the substrate layer comprises a plurality of microfibers.

8. The filtration medium of claim 7, wherein the nanofibers are covalently bonded to the microfibers.

9. The filtration medium of claims 7-8, wherein the nanofibers and microfibers have an adhesion strength higher than 0.01 N.

10. The filtration medium of claim 7, wherein the substrate layer is selected from the group consisting of polypropylene (PP), polyethylene (PE), polyethyleneterephthalate (PET), PET reinforced glass fibers, or a combination thereof.

11. The filtration medium of claim 6, wherein the nanofibers are made of a polymer material selected from the group consisting of polyvinylidene fluoride (PVDF), poly(vinylidene fluoride-co-hexafluoropropene) (PVDF-co-HFP), polyamide 6 (PA-6), poly(hexamethyleneadipamide), polystyrene, polysulfone, polyethersulfone, polyethylene oxide, polyvinyl chloride, cellulose acetate, chitosan, zein, or a combination thereof.

12. The filtration medium of claim 6, wherein the filtration medium is used in an air filter and the nanofiber layer has an air permeability range of 4-20 cm³/cm²/s.

13. The filtration medium of claim 6, wherein the nanofiber layer is treated with antimicrobial agents to prevent microbial activity in a filtrate when the filtration medium is used as a filter for the filtrate and to prevent biological contamination of the filtration medium.

14. The filtration medium of claim 6, wherein the nanofiber layer is treated with volatile organic compound (VOC) removal agents.

15. The filtration medium of claim 6, wherein the filtration medium is a high efficiency particulate air (HEPA) filter having a E13 level of filtration efficiency.

16. A method of preparing a filtration medium, comprising:
providing a substrate layer;
producing threads of nanofibers containing beads that are irregularly dispersed along a length of each nanofiber to generate a plurality of beaded nanofibers;
depositing the beaded nanofibers onto a surface of the substrate layer to create a coating of randomly oriented interwoven beaded nanofibers with three-dimensional pores of 5-50 μm to produce a nanofiber filtration layer.

17. The method of claim 16, wherein the nanofibers are produced by free surface electrospinning.

18. The method of claim 16, wherein the substrate layer comprises microfibers.

19. The method of claim 18, wherein the microfibers are treated with an atmospheric plasma treatment (APT) system before the beaded nanofibers are deposited.

20. The method of claim 16, wherein the filtration medium is folded.

21. The method of claims 16 and 18, wherein a diameter of the microfibers range from 2-30 μm, a diameter of the nanofibers range from 10-1000 nm, and a diameter of the beads range from 2-20 μm.
